(19) United States
(12) Patent Application Publication
(10) Pub. No.: US 2006/0085414 A1
(43) Pub. Date: Apr. 20, 2006

(54) System and methods for reference resolution

(75) Inventors: Joyce Yue Chai, Okemos, MI (US); Pengyu Hong, Waltham, MA (US); Michelle Xue Zhou, Briarcliff Manor, NY (US)

Correspondence Address: Ryan, Mason & Lewis, LLP, Suite 205, 1300 Post Road, Fairfield, CT, 06824, US

(73) Assignee: International Business Machines Corporation, Armonk, NY (US)

(21) Appl. No.: 10/955,190

(22) Filed: Sep. 30, 2004

(51) Int. Cl. G06F 17/30

(52) U.S. Cl. 707/5

(57) ABSTRACT

Reference resolution may be modeled as an optimization problem, where certain techniques disclosed herein can identify the most probable references by simultaneously satisfying a plurality of matching constraints, such as semantic, temporal, and contextual constraints. Two structures are generated. The first comprises information describing one or more referring expressions and describing relationships, if any, between the one or more referring expressions. The second comprises information describing one or more referents to which the one or more referring expressions might refer and describing relationships, if any, between the one or more referents. Matching is performed, by using the structures, to match a given one of the one or more referring expressions to at least a given referent. Matching simultaneously satisfies a plurality of matching constraints corresponding to the one or more referring expressions and the one or more referents, and also resolves one or more references by the given referring expression to the at least a given referent.

### FIELD OF THE INVENTION

The present invention relates generally to the field of multimodal interaction systems, and relates, in particular, to reference resolution in multimodal interaction systems.

### BACKGROUND OF THE INVENTION

Multimodal interaction systems provide a natural and effective way for users to interact with computers through multiple modalities, such as speech, gesture, and gaze. One important but also very difficult aspect of creating an effective multimodal interaction system is to build an interpretation component that can accurately interpret the meanings of user inputs. A key interpretation task is reference resolution, which is a process that finds the most proper referents to referring expressions. Here, a referring expression is an expression that is given by a user in her inputs (e.g., most likely in more expressive inputs, such as speech inputs) to refer to a specific object or objects. A referent is an object to which the user refers in the referring expression. For instance, suppose that a user points to a particular house on the screen and says, “how much is this one?” In this case, reference resolution is used to assign the referent—the house object—to the referring expression “this one.”

In a multimodal interaction system, users may make various types of references depending on interaction context. For example, users may refer to objects through the usage of multiple modalities (e.g., pointing to objects on a screen and uttering), by conversation history (e.g., “the previous one”), and based on visual feedback (e.g., “the red one in the center”). Moreover, users may make complex references (e.g., “compare the previous one with the one in the center”), which may involve multiple contexts (e.g., conversation history and visual feedback).

To identify the most probable referent for a given referring expression, researchers have employed rule-based approaches (e.g., unification-based approaches or finite state approaches). Since these rules are usually pre-defined to handle specific user referring behaviors, additional rules are required if a specific user referring behavior did not exactly match any existing rule (e.g., temporal relations).

Since it is difficult to predict how a course of user interaction could unfold, it is impractical to formulate all possible rules in advance. Consequently, there is currently no way to dynamically accommodate a wide variety of user reference behaviors.

What is needed then are techniques for reference resolution allowing dynamic accommodation of a wide variety of reference behaviors, where the techniques can be used in multimodal interaction systems.

### SUMMARY OF THE INVENTION

The present invention provides techniques for reference resolution. Such techniques can dynamically accommodate a wide variety of user reference behaviors and are particularly useful in multimodal interaction systems. Specifically, the reference resolution may be modeled as an optimization problem, where certain techniques disclosed herein can identify the most probable references by simultaneously satisfying a plurality of matching constraints, such as semantic, temporal, and contextual constraints.

For instance, in an exemplary embodiment, two structures are generated. The first structure comprises information describing one or more referring expressions and describing relationships, if any, between the one or more referring expressions. The second structure comprises information describing one or more referents to which the one or more referring expressions might refer and describing relationships, if any, between the one or more referents. Matching is performed, by using the first and second structures, to match a given one of the one or more referring expressions to at least a given one of the one or more referents. The step of matching simultaneously satisfies a plurality of matching constraints corresponding to the one or more referring expressions and the one or more referents. The step of matching also resolves one or more references by the given referring expression to the at least a given referent.

A more complete understanding of the present invention, as well as further features and advantages of the present invention, will be obtained by reference to the following detailed description and drawings.

### BRIEF DESCRIPTION OF THE DRAWING

FIG. 1 is a block diagram of an exemplary multimodal interaction system in accordance with a preferred embodiment of the invention;

FIG. 2 is an exemplary embodiment of a reference resolution module, shown along with exemplary matching between a generated referring structure and a generated referent structure, in accordance with a preferred embodiment of the invention;

FIG. 3 is a flowchart of an exemplary method for creating a referring structure, in accordance with a preferred embodiment of the invention;

FIG. 4 illustrates an example of a referring structure generated, using the method in FIG. 3, from a speech utterance, in accordance with a preferred embodiment of the invention;

FIG. 5 is a flowchart of an exemplary method for creating referent structures and for merging the referent structures into a single referent structure, in accordance with a preferred embodiment of the invention;

FIG. 6 is a flowchart of an exemplary method for creating a referent structure from a user input that includes multiple interaction events, in accordance with a preferred embodiment of the invention;

FIG. 7 is a flowchart of an exemplary method of creating a referent structure from a single interaction event within an input, in accordance with a preferred embodiment of the invention;

FIG. 8 is a flowchart of an exemplary method for merging two referent sub-structures into an integrated referent structure, in accordance with a preferred embodiment of the invention;

FIG. 9 illustrates an example of a referent structure generated, in accordance with a preferred embodiment of the invention, from gesture inputs with two interaction events: a pointing gesture and a circling gesture;

FIG. 10 is a flowchart of an exemplary method for creating a referent structure from context, in accordance with a preferred embodiment of the invention;

FIG. 11 illustrates an example in accordance with a preferred embodiment of the invention of a referent structure generated from recent conversation history;

FIG. 12 illustrates an example of generating a referring structure and a single aggregate referent structure in accordance with a preferred embodiment of the invention; and

FIG. 13 is a flowchart of an exemplary method for matching referring expressions represented by a referring structure with referents represented by a referent structure in accordance with a preferred embodiment of the invention.

### DETAILED DESCRIPTION OF PREFERRED EMBODIMENTS

In certain exemplary embodiments, the present invention provides a framework, system, and methods for multimodal reference resolution. The invented framework can, for instance, integrate information from a number of inputs to identify the most probable referents by simultaneously satisfying various matching constraints. The satisfaction of the matching constraints occurs simultaneously, meaning that the satisfaction of the matching constraints occurs at the same time. “Simultaneous satisfaction” means that every match (e.g., a matching result) meets the matching constraints possibly within a small error. In an example, a probability is used to measure how well the matching constraints are satisfied. The higher the probability value, the better the match. In particular, certain embodiments of the present invention can include, but are not limited to, one or more of the following:

1) A multimodal interaction system that utilizes a reference resolution component to interpret meanings of various inputs, including ambiguous, imprecise, and complex references.

2) Methods for representing and capturing referring expressions on inputs, along with relevant information, including semantic and temporal information for the referring expressions.

3) Methods for representing, identifying, and capturing all potential referents from different sources, including additional modalities, conversation history, and visual context, with associated information, such as semantic and temporal, between the referents.

4) Methods for connecting potential referents together to form an integrated referent structure based on various relationships, such as semantic and temporal relationships.

5) An optimization-based approach that assigns the most probable potential referent or referents to each referring expression by satisfying matching constraints such as temporal, semantic, and contextual constraints for the referring expressions and the referents.

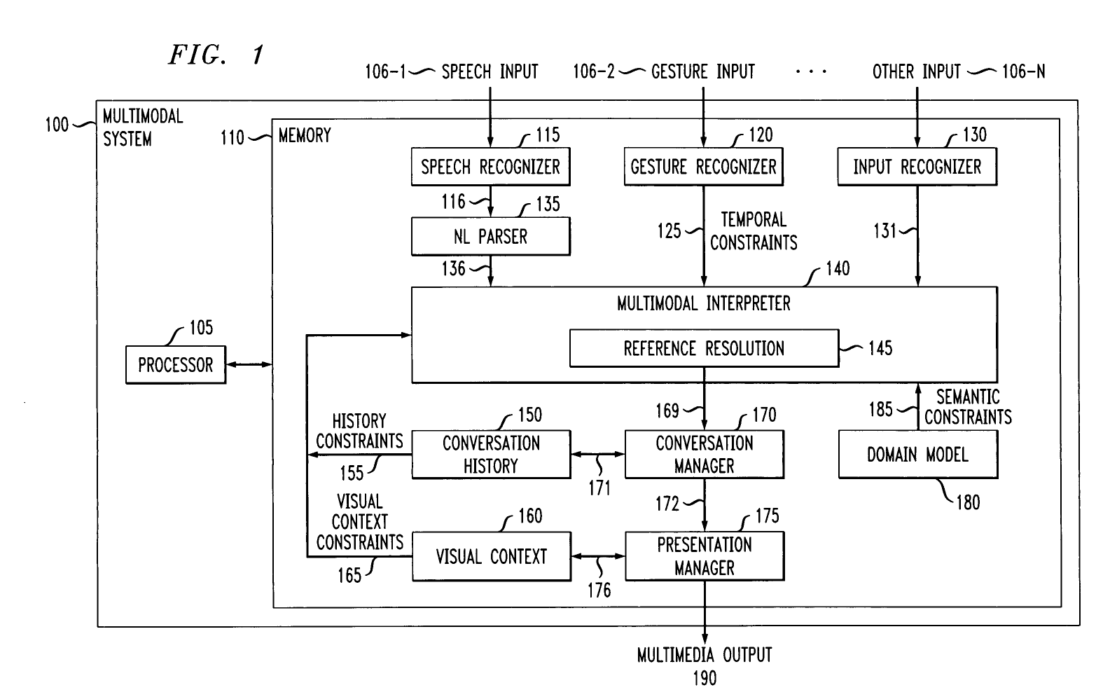

Turning now to FIG. 1, an exemplary embodiment of a multimodal interaction system 100 is shown. Multimodal interaction system 100 accepts a number, N, of different inputs, of which speech input 106-1, gesture input 106-2, and other input 106-N are shown, and produces multimedia output 190. The multimodal interaction system 100 comprises a processor 105 coupled to a memory 110. Memory 110 comprises a speech recognizer 115 producing text 116, a gesture recognizer 120 producing temporal constraints 125, an input recognizer 130 producing recognized input data 131, a Natural Language (NL) parser 135 that produces natural language text 136, a multimodal interpreter module 140, a conversation history database 150 that provides history constraints 155, a visual context database 160 that provides visual context constraints 165, a conversation manager 170, a domain database 180 that provides semantic constraints 185 for the particular domain, and a presentation manager module 175. The conversation manager module 170 receives interpreted output 169, which the conversation manager module 170 uses to add (through connection 171) to the conversation history database 150 and sends to the presentation manager module 175 using connection 172. The presentation manager module 175 produces the multimedia output 190 and updates the visual context database 160 using connection 176. The multimodal interpreter module 140 comprises a reference resolution module 145 containing one or more embodiments of the present invention.

Given user multimodal inputs, such as speech from speech input 106-1 and gestures from gesture input 106-2, respective recognition and understanding components (e.g., speech recognizer 115 and NL parser 135 for speech input 106-1 and gesture recognizer 120 for gesture input 106-2) can be used to process the inputs 106. Based on processed inputs (e.g., natural language text 136 and temporal constraints 125), the multimodal interpreter module 140 infers the meaning of these inputs 106. During the interpretation process, reference resolution, a key component of the multimodal interpreter module 140, is performed by the reference resolution module 145 to determine proper referents for referring expressions in the inputs 106.

Exemplary reference resolution methods performed by the reference resolution module 145 can not only use inputs from different modalities, but also can systematically incorporate information from diverse sources, including such sources as conversation history database 150, visual context database 160, and domain model database 180. Accordingly, each type of information may be modeled as matching constraints, including temporal constraints 125, conversation history context constraints 155, visual context constraints 165, and semantic constraints 185, and these matching constraints be used to optimize the reference resolution process. Note that contextual information may be managed or provided by multiple components. For example, the presentation manager 175 provides the visual context in visual context database 160 and the conversation manager 170 may supply the conversation history context in conversation history database 150 and to, through connection 172, the presentation manager module 175.

It should also be noted that memory 110 can be singular (e.g., in a single multimodal interaction system) or distributed (e.g., in multiple multimodal interaction systems interconnected through one or more networks). Similarly, the processor may be singular or distributed (e.g., in one or more multimodal interaction systems). Furthermore, the techniques described herein may be distributed as an article of manufacture that itself comprises a computer-readable medium containing one or more programs, which when executed implement one or more steps of embodiments of the present invention.

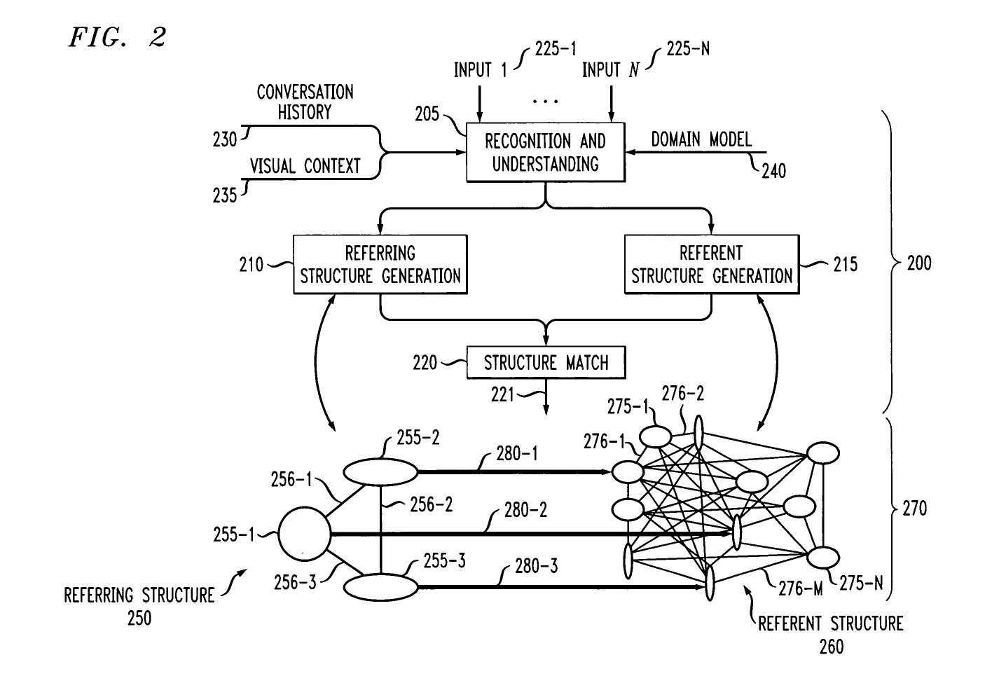

Turning now to FIG. 2, an exemplary embodiment of a reference resolution module 200 is shown, as is exemplary matching between a generated referring structure and a generated referent structure, in accordance with a preferred embodiment of the invention. The reference resolution module 200 is an example of reference resolution module 145 of FIG. 1 and may be considered to be a framework for determining reference resolutions.

The reference resolution module 200 comprises a recognition and understanding module 205 and a structure matching module 220. The recognition and understanding module 205 uses matching constraints determined from inputs 225-1 through 225-N (e.g., speech input 106-1 or gesture input 106-2 or both of FIG. 1), conversation history 230 (e.g., from conversation history database 150), visual context 235 (e.g., from visual context 160), and a domain model 240 (e.g., from domain model database 180) when performing the steps of referring structure generation 210 and referent structure generation 215. The step of referring structure generation 210 creates a referring structure (e.g., referring structure 250), and the step of referent structure generation creates a referent structure (e.g., referent structure 260). In an exemplary embodiment, the recognition and understanding module 205 therefore takes matching constraints into account when creating the referring structure 250 and the referent structure 260, and certain information comprised in the structures 250 and 260 is defined by the matching constraints.

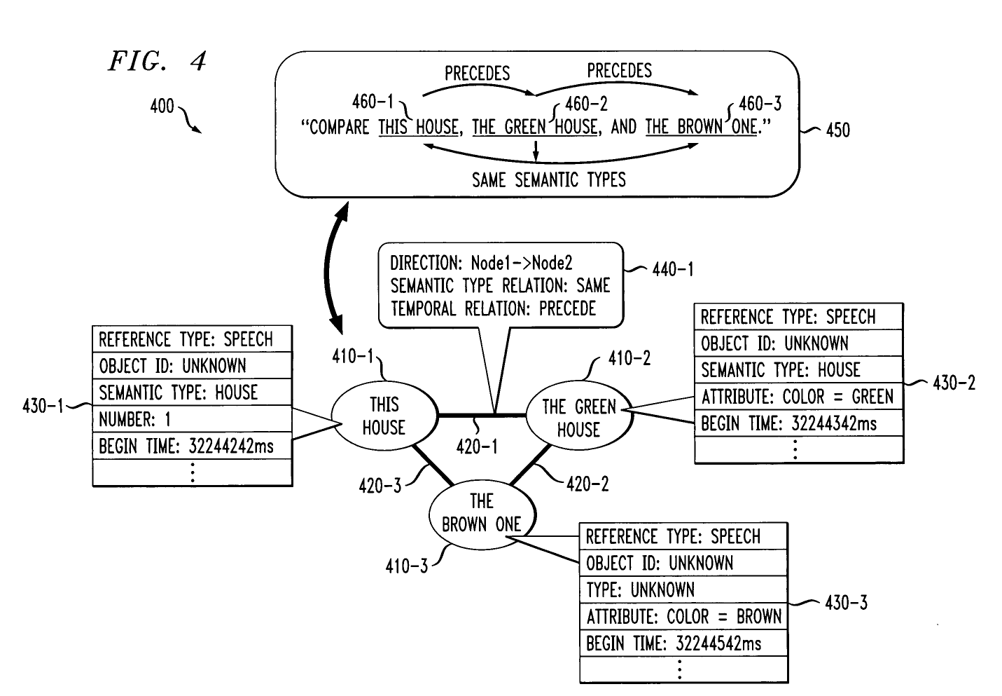

The structure matching module 220 finds one or more matches between two structures: the referring structure 250 and the referent structure 260. An exemplary embodiment of each of these structures 250 and 260 is a graph. The referring structure 250 comprises information describing referring expressions, which often are generated from expressions on user inputs, such as speech utterances and gestures or portions thereof. The referring structure 250 also comprises information describing relationships, if any, between referring expressions. In an exemplary embodiment, each node 255 (e.g., nodes 255-1 through 255-3 in this example), corresponding to a referring expression, comprises a feature set describing referring expressions. Such a feature set can include the semantic information extracted from the referring expression and the temporal information about when the referring expression was made. Each edge 256 (e.g., edges 256-1 through 256-3 are shown) represents one or more relationships (e.g., semantic relationships) between two referring expressions and may be described by a relationship set (shown in FIG. 4 for instance).

A referent structure 260, on the other hand, comprising information describing potential referents (such as objects selected by a gesture in an input 225, objects existing in conversation history 230, or objects in a visual display determined using visual context 235) to which referring expressions might refer. Furthermore, a referent structure 260 comprises information describing relationships, if any, between potential referents. The referent structure 260 comprises nodes 275 (e.g., nodes 275-1 through 275-N are shown), where each node 275 is associated with a feature set (e.g., the time when the potential referent was selected by a gesture) describing potential referents. Each edge 276 (e.g., edges 276-1 through 276-M are shown) describes one or more relationships (e.g., semantic or temporal) between two potential referents.

Given these two structures 250 and 260, reference resolution may be considered a structure-matching problem that, in an exemplary embodiment, matches (e.g., indicated by matching connections 280-1 through 280-3) one or more nodes in the referent structure 260 to each node in the referring structure 250 that achieves the most compatibility between two structures 250 and 260. This problem can be considered to be an optimization problem, where one type of optimization problem selects the most probable referent or referents (e.g., described by nodes 275) for each of the referring expressions (e.g., described by nodes 255) by simultaneously satisfying matching constraints including temporal, semantic, and contextual constraints (e.g., determined from inputs 225, conversation history 230, visual context 235, and the domain model 240) for the referring expressions and the referents. It should be noted that the most probable referent may not be the “best” referent. Moreover, optimization need not produce an ideal solution.

Depending on the limitations of recognition or understanding components in the module 205 and available information, a connected referent/referring structure 270 may not be able to be obtained. In this case, methods (e.g., a classification method) can be employed to match disconnected structural fragments.

It should be noted that the structures 250 and 260 will be described herein as being graphs, but any structures may be used that are able to have information describing referring expressions and the relationships therebetween and to have information describing potential referents and the relationships therebetween.

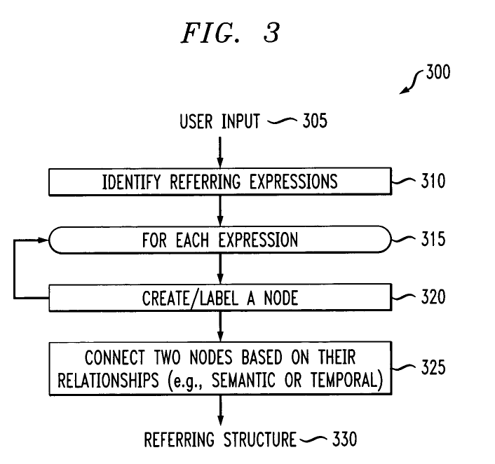

Referring now to FIG. 3, an exemplary method 300 is shown for creating a referring structure (e.g., a graph), in accordance with a preferred embodiment of the invention. Method 300 would typically be performed by the referring structure generation module 210 of FIG. 2. The exemplary method 300 creates a referring structure 330 that captures information about referring expressions and relationships therebetween that occur in a user input 305. This method 300 can be directly used to create referring structures 330 for a number of user inputs 305, such as natural language text inputs or facial expressions.

Method 300, in step 310, identifies referring expressions. For example, in a speech utterance “compare this house, the green house, and the brown one,” there are three referring expressions: “this house”; “the green house”; and “the brown one.” Such identification in step 310 may be performed by recognition and understanding engines, as is known in the art. Based on the number of identified referring expressions (step 315), three nodes are created in step 320. Each node is labeled with a set of features describing each referring expression. This occurs in step 320 also. In step 325, two nodes are connected by an edge based on one or more relationships between the two nodes. Step 325 is performed until all nodes having relationships between the nodes have been connected by edges. Information is used to describe the edges and the relationships between the connected nodes.

FIG. 4 illustrates an example of a referring structure 400 generated from a speech utterance 450 using method 300 in FIG. 3, in accordance with a preferred embodiment of the invention. As previously described, based on the identified referring expressions 460-1 through 460-3, three nodes 410-1 through 410-3 respectively are created. In an exemplary embodiment, each node 410 is labeled with a set of features (feature sets 430-1 through 430-3) that describe each referring expression 460:

1) The reference type, such as speech, gesture, and text.

2) The identifier of a potential referent. The identifier provides a unique identity of the potential referent. For example, the proper noun “Ossining” specifies the town of Ossining. In the example of FIG. 4, there are no known potential referents (e.g., “Object ID” is “Unknown” in sets 430-1 through 430-3).

3) The semantic type of the potential referents indicated by the expression. For example, the semantic type of the referring expression “this house” is a semantic type “house.”

4) The number of potential referents. For example, a singular noun phrase refers to one object. A plural noun phrase refers to multiple objects. A phrase like “three houses” provides the exact number of referents (i.e., three).

5) Type dependent features. Any features, such as size and price, are extracted from the referring expression. See “Attribute: color=Green” in feature set 430-2.

6) The time stamp (e.g., BeginTime) that indicates when a referring expression is uttered.

The edges 420-1 through 420-3 would also have sets of relationships associated therewith. For example, the relationship set 440-1 describes the direction (e.g., “Node1->Node2”), the semantic type relationship of “Same,” and the temporal relationship of “Precede.”

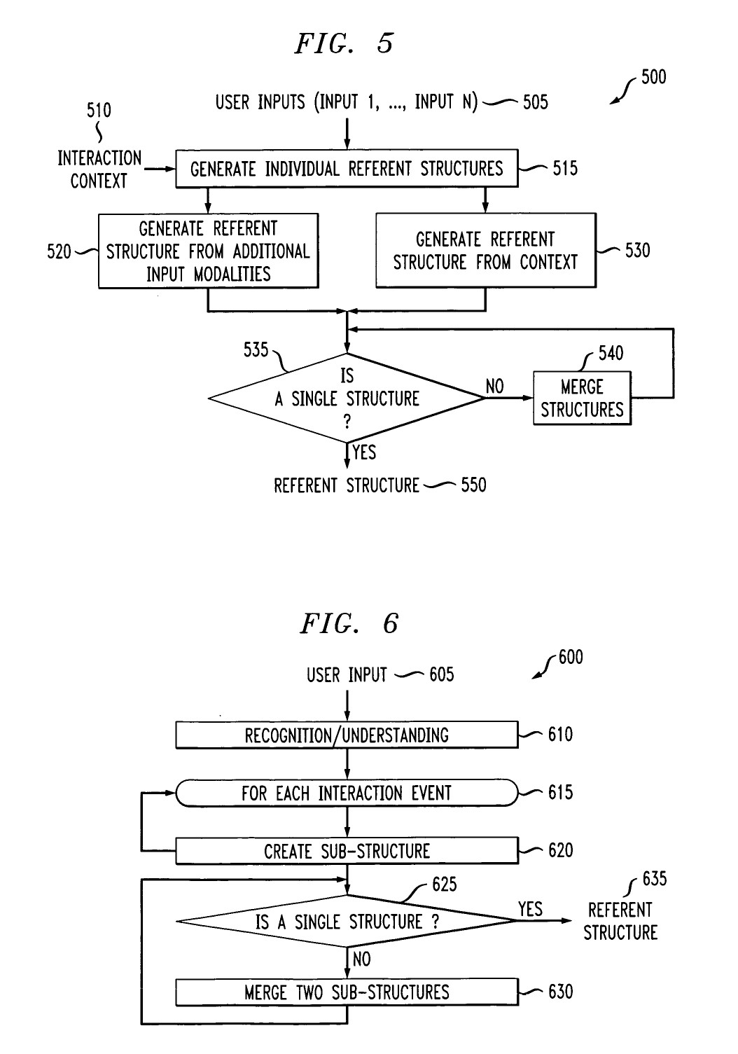

Referring now to FIG. 5, an exemplary method 500 is shown for creating referent structures and for merging the referent structures into a single referent structure. Method 500 is typically performed by a referent structure generation module 215, as shown in FIG. 2. In step 515, individual referent structures are created from various sources (e.g. user inputs 505) to provide potential referents. In step 515, interaction context is also used during generation of individual referent structures. There are two major sources for producing referent structures: additional input modalities (step 520) and conversation context (step 530). Conversation context can be conversation history (e.g., conversation history 230 of FIG. 2) and visual context (e.g., visual context 235 of FIG. 2), for example. In step 535, it is determined if there is a single referent structure. If not (step 535=No), two referent structures are merged in step 540 and method 500 again performs step 535. If so (step 535=Yes), then a single referent structure 550 has been created.

FIG. 6 is a flowchart of an exemplary method 600 for creating a referent structure from a user input that includes multiple interaction events. Method 600 is one example of step 515 of FIG. 5. Method 600 is implemented for creating a referent structure from a single input modality (e.g., user input 605), such as a gesture or gaze, which directly manipulates objects. In step 610, a recognition or understanding or both analysis is performed to determine multiple interaction events for one interaction between a user and a computer system. For instance, since there may be multiple interaction events (e.g., multiple pointing events or gazes) that have occurred during each interaction (e.g., a completed series of pointing events or gazes), for each interaction event (step 615), method 600 builds a referent sub-structure (step 620). If there are multiple referent sub-structures that have been created (step 625=No), method 600 merges the referent sub-structures into a single referent structure 635 using steps 630 and 625.

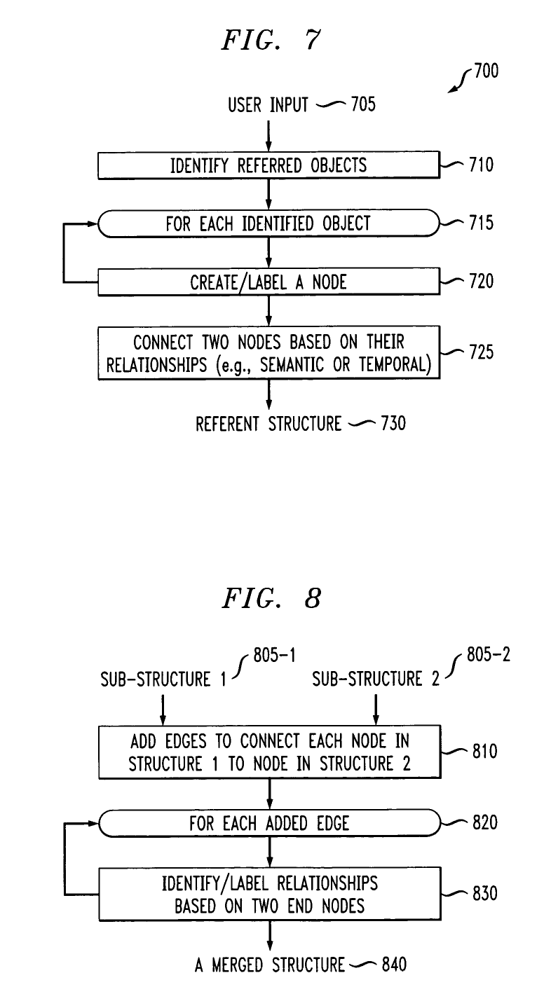

FIG. 7 shows an exemplary method 700 of creating a referent structure from a single interaction event within a user input 705. FIG. 7 is another example of step 515 of FIG. 5. In step 710, potential objects involved in an interaction event of the user input 705 are identified. For instance, using a modality (e.g., gesture) recognition module, step 710 could identify all the potential objects being involved in an interaction event. For example, from a simple pointing gesture (e.g., FIG. 6), a gesture recognition module may return a list of potential objects (House2, House7, House 10, and Ossining). Each object may be also associated with a probability, since the recognition may be inaccurate (e.g., a touch screen pointing gesture may be imprecise and potentially involve multiple objects on the screen).

For each identified object (step 715), a node is created and labeled (step 720). For instance, each node, representing an object identified by the interaction event (e.g., a pointing gesture or gaze), may be created and labeled with a set of features, including an object identifier, a unique identifier, a semantic type, attributes (e.g., a house object has attributes of price, size, and number of bedrooms), the selection probability for the object, and the time stamp when the object is selected (relative to the system start time). Each edge in the structure represents one or more relationships between two nodes (e.g., a temporal relationship). Edges are created between pairs of nodes in step 725, and a referent structure 730 results from method 700.

Turning now to FIG. 8, an exemplary method 800 is shown for merging two referent sub-structures 805-1 and 805-2 to create a merged referent structure 840. Method 800 is an example of step 540 of FIG. 5 or step 630 of FIG. 6. In step 810, new edges are added based on the temporal order of interaction events to connect the nodes in two structures (e.g., a pointing gesture occurs before a circling gesture). These new edges link each node of one structure to each node of the other. For each added edge (step 820), additional features (e.g., semantic relation) of the new edges are identified based on the node features (e.g., node type) and are labeled (step 830).

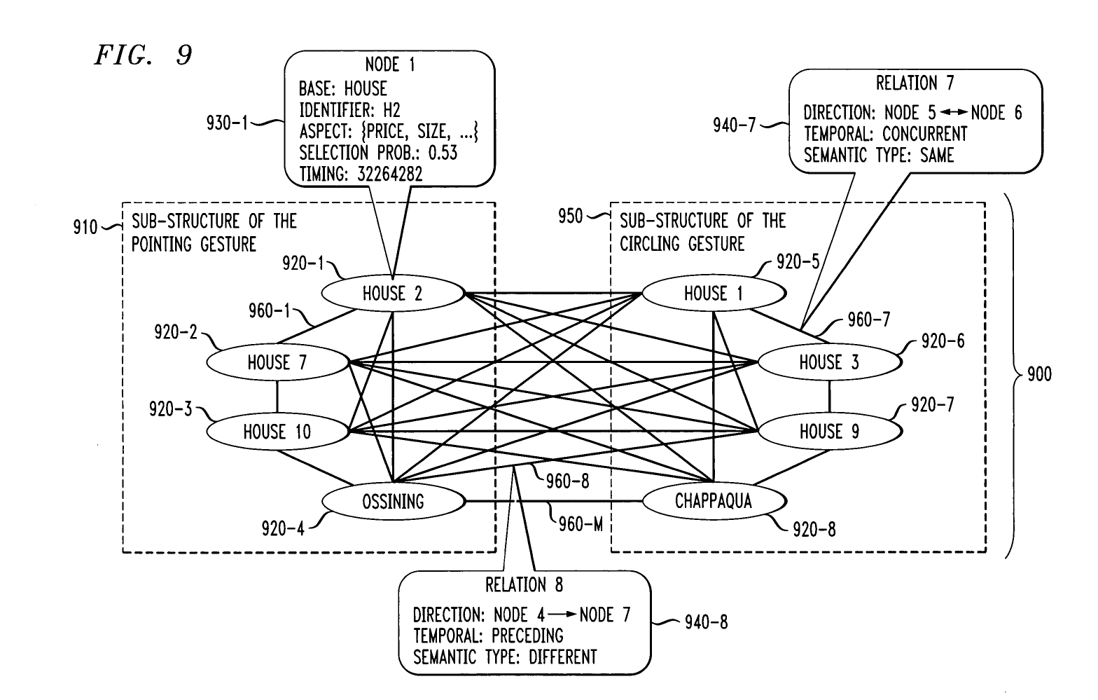

FIG. 9 illustrates an example of a merged referent structure 900 generated, in accordance with a preferred embodiment of the invention, from gesture inputs with two interaction events: a pointing gesture and a circling gesture. FIG. 9 shows a referent sub-structure 910 (e.g., generated for a pointing gesture) and a referent sub-structure 950 (e.g., a following circling gesture) that have been merged using, for instance, method 800 of FIG. 8 to form merged referent structure 900. Referent sub-structure 910 comprises nodes 920-1 through 920-4, which referent sub-structure 950 comprises nodes 920-5-5 through 920-8. These referent sub-structures of the pointing gesture (i.e., referent sub-structure 910) and the circling gesture (i.e., referent sub-structure 950) are connected to form the final gesture referent structure 900. Each node 920 has a feature set 930 (of which feature set 930-1 is shown) and each edge 960 has a relationship set 940 (of which relationship sets 940-7 and 940-8 are shown).

Feature set 930 comprises information describing one or more referents to which one or more referring expressions might refer. In an exemplary embodiment, feature set 930 comprises one or more of the following:

1) An object identifier. The object identifier (shown as “Base” in FIG. 9) identifies the referent, such as “House” or “Ossining.”

2) A unique identifier. The unique identifier identifies the referent and is particularly useful when there are multiple similar referents (such as houses in this example). Note that the object and unique identifiers may be combined, if desired.

3) Attributes (shown as “Aspect” in FIG. 9). Attributes are features of the referent, such as price, size, location, number of bedrooms, and the like.

4) A selection probability. The selection probability is a likelihood (e.g., determined using an expression generated by a user) that a user has selected this referent.

5) A time stamp (shown as “Timing” in FIG. 9). The time stamp is when the object is selected (e.g., relative to the system start time).

Each edge 960 has a relationship set 940 comprising information describing relationships, if any, between the referents. For instance, relationship set 940-7 has a direction indicating a director of a temporal relation, a temporal relation of “Concurrent,” and a semantic type of “Same.”

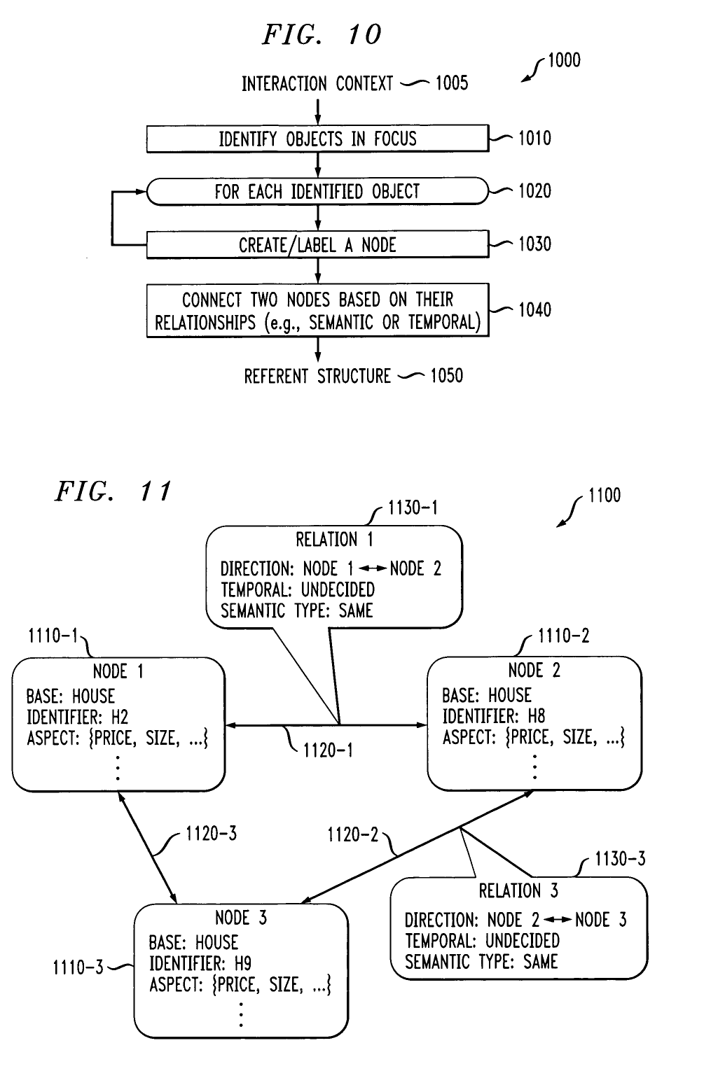

FIG. 10 is an exemplary embodiment of a method 1000 for creating a referent structure 1050 from interaction context 1005 (e.g., conversation history or visual context). Method 1000 is an example of step 515 of FIG. 5. Method 1000 begins in step 1010, when objects that are in focus (e.g., conversation focus or visual focus) are identified based on a set of criteria. For example, a history referent structure is concerned with objects that are in focus during the most recent interaction. For each identified object (step 1020), nodes are labeled or created or both (step 1030). Each node in such a graph contains information, such as an identifier for the node, a semantic type, and the attributes being mentioned. Each edge represents one or more relationships (e.g., a semantic relationship) between two nodes, and two nodes are connected based on their relationships (step 1040).

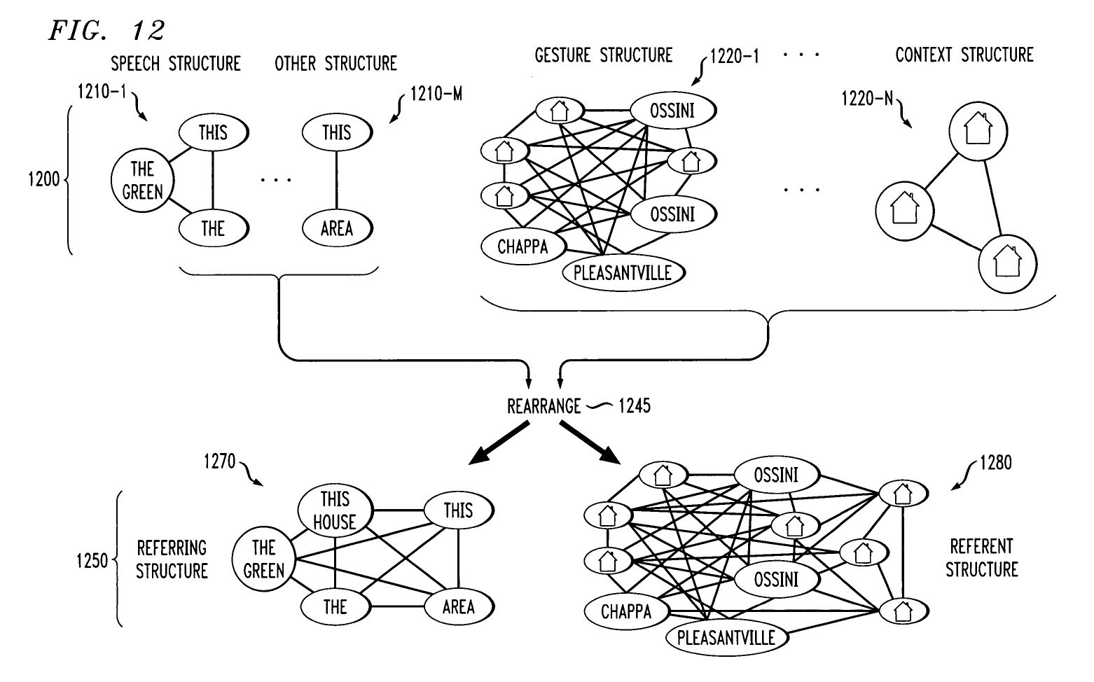

FIG. 11 shows an example of a referent structure 1100 created based on recent conversation history. In particular, three houses, represented by nodes 1110-1 through 1110-3, have been mentioned most recently. In this example, a node is represented and described by a feature set. Also shown are the edges 1120-1 through 1120-3, which are represented and described by relationship sets 1130-1 through 1130-3, respectively. The referent structure 1100 can be used for reference resolution in, for example, a turn in a conversation when a user adds an expression.

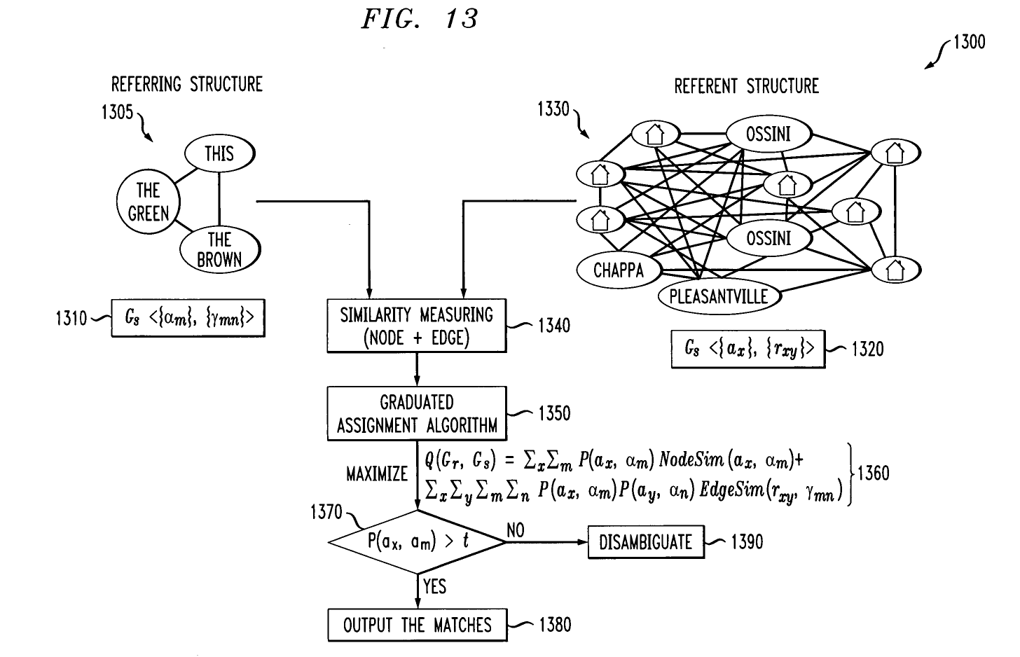

FIG. 12 shows an example of generating a referring structure 1270 from M referring structures 1210. FIG. 12 also shows an example of generating a single aggregated referent structure 1280 that combines all referent structures 1220-1 through 1220-N created from various sources (e.g., input modality or context). Similar to merging two referring or referent sub-structures together (e.g., FIG. 7), multiple referring or referent structures may be merged easily. The inputs 1200 are rearranged 1245 into outputs 1250. As a result, in this example, every node in one referring structure (e.g., referring structure 1220-1) is connected to every node in another referring structure (e.g., referring structure 1120-M). Similarly, every node in one referent structure (e.g., referent structure 1220-1) is connected to every node in another referent structure (e.g., referent structure 1220-N) to create the aggregated referent structure 1280. Each of the added edges indicates the relationships (e.g., the semantic equivalence) between two connected nodes, as previously described.

Turning now to FIG. 13, an exemplary method 1300 is shown for matching referring expressions represented by a referring structure with referents represented by a referent structure.

The referring structure 1305 may represented as follows: Gₛ=<{αₘ}, {γₘₙ}>, where {αₘ} is the node list and {γₘₙ} is the edge list. The edge γₘₙ connects nodes αₘ and αₙ. The nodes of Gₛ are called referring nodes.

The referent structure 1330 may be represented as follows: Gᵣ=<{aₓ}, {r_{xy}}>, where {aₓ} is the node list and {r_{xy}} is the edge list. The edge r_{xy} connects nodes aₓ and a_{y}. The nodes of Gᵣ are called referent nodes.

Method 1300 uses two similarity metrics to compute similarities between the nodes NodeSim(aₓ, αₘ) and the edges EdgeSim(r_{xy},γₘₙ) in the two structures 1305 and 1330. This occurs in step 1340. Each similarity metric compares a distance between properties (e.g., including matching constraints) of two nodes (NodeSim) or edges (EdgeSim). As described previously, generation of the structures 1305 and 1330 takes into account certain matching constraints (e.g., semantic constraints, temporal constraints, and contextual constraints) and the similarity metrics use values corresponding to the matching constraints when computing similarities. In step 1350, a graduated assignment algorithm is used to compute matching probabilities of two nodes P(aₓ,αₘ) and edges P(aₓ,αₘ) P(a_{y},αₙ). A reference that describes an exemplary graduated assignment algorithm is Gold, S. and Rangarajan, A., “IEEE Transaction Pattern Analysis and Machine Intelligence,” vol. 18, no. 4 (1996), the disclosure of which is hereby incorporated by reference. The term P(aₓ,αₘ) may be initialized using a pre-defined probability of node aₓ (e.g., the selection probability from a gesture graph). Adopting the graduated assignment algorithm, step 1350 iteratively updates the values of P(aₓ,αₘ) until the algorithm converges, which maximizes the following (see 1360):
Q(Gᵣ,Gₛ)=ΣₓΣₘP(aₓ,αₘ)NodeSim(aₓ,αₘ)+ΣₓΣ_{y}ΣₘΣₙP(aₓ,αₘ)P(a_{y},αₙ)EdgeSim(r_{xy},γₘₙ).

When the algorithm converges, P(aₓ,αₘ) is the matching probability between a referent node aₓ and a referring node αₘ. Based on the value of P(aₓ,αₘ), a method 1300 decides whether a referent is found for a given referring expression in step 1370. If P(aₓ, αₘ) is greater than a threshold (e.g., 0.8) (step 1370=Yes), method 1300 considers that referent aₓ is found for the referring expression αₘ and the matches (e.g., nodes aₓ and αₘ) are output (step 1380). On the other hand, there is an ambiguity if there are two or more nodes matching αₘ and αₘ is supposed to refer to a single object. In this case, a system can ask the user to further clarify the object of his or her interest (step 1390).

It should be noted that a user study involving an exemplary implementation of the present invention was presented in “A Probabilistic Approach to Reference Resolution in Multimodal User Interfaces,” by J. Chai, P. Hong, and M. Zhou, Int'l Conf. on Intelligent User Interfaces (IUI) 2004, 70-77 (2004), the disclosure of which is hereby incorporated by reference.

It is to be understood that the embodiments and variations shown and described herein are merely illustrative of the principles of this invention and that various modifications may be implemented by those skilled in the art without departing from the scope and spirit of the invention.

What is claimed is:

1. A method for reference resolution, the method comprising the steps of:
generating a first structure comprising information describing one or more referring expressions and describing relationships, if any, between the one or more referring expressions;
generating a second structure comprising information describing one or more referents to which the one or more referring expressions might refer and describing relationships, if any, between the one or more referents; and
matching, by using the first and second structures, a given one of the one or more referring expressions to at least a given one of the one or more referents, the step of matching simultaneously satisfying a plurality of matching constraints corresponding to the one or more referring expressions and the one or more referents, wherein the step of matching resolves one or more references by the given referring expression to the at least a given referent.

2. The method of claim 1, wherein the step of matching further comprises the step of matching, by using the first and second structures, a given one of the one or more referring expressions to at least a given one of the one or more referents, the step of matching simultaneously satisfying a plurality of matching constraints comprising one or more of semantic constraints, temporal constraints, and contextual constraints for the one or more referring expressions and the one or more referents, wherein the step of matching resolves one or more references by the given referring expression to the at least a given referent.

3. The method of claim 1, wherein the step of matching further comprises the step of matching, by using the first and second structures, a given one of the one or more referring expressions to at least a given one of the one or more referents, the step of matching simultaneously satisfying a plurality of matching constraints comprising one or more of semantic constraints, temporal constraints, and contextual constraints for the one or more referring expressions and the one or more referents, wherein the step of matching resolves every reference by each of the one or more referring expressions to at least a given one of the one or more referents.

4. The method of claim 1, wherein the step of generating a first structure further comprises the steps of:
identifying the one or more referring expressions from one or more user inputs;
for each of the one or more referring expressions, performing the steps of:
selecting one of the one or more referring expressions; and
determining the information describing the selected referring expression; and
determining the information describing relationships between the one or more referring expressions, the information describing relationships comprising at least which of the one or more referring expressions should be connected to another of one or more referring expressions.

5. The method of claim 4, wherein the step of identifying the one or more referring expressions from one or more user inputs further comprises the step of identifying the one or more referring expressions from one or more of a speech input, a gesture input, a natural language input, and a visual input.

6. The method of claim 1, wherein:
the step of generating a first structure further comprises the step of generating a first graph comprising one or more first nodes interconnected through one or more first edges, each first node associated with information describing one or more referring expressions, each first edge associated with information describing relationships, if any, between the one or more referring expressions;
the step of generating a second structure further comprises the step of generating a second graph comprising one or more second nodes interconnected through one or more second edges, each second node associated with information describing one or more referents to which the one or more referring expressions might refer, and each second edge associated with information describing relationships, if any, between the one or more referents; and
the step of matching further comprises matching, by using the first and second graphs, a given one of the one or more referring expressions to at least a given one of the one or more referents considered to be most probable referents by optimizing satisfaction of the one or more matching constraints for the one or more referring expressions and the one or more referents.

7. The method of claim 6, wherein:
the step of generating a first graph further comprises the step of generating the first graph Gₛ=<{αₘ}, {γₘₙ}>, wherein {αₘ} is a node list corresponding to the first nodes, {γₘₙ} is an edge list corresponding to the first edges, and a given first edge γₘₙ connects first nodes αₘ and αₙ;
the step of generating a second graph further comprises the step of generating the second graph Gᵣ=<{aₓ}, {r_{xy}}>, wherein {aₓ} is a node list corresponding to the second nodes, {r_{xy}} is an edge list corresponding to the second edges, and a given second edge r_{xy} connects second nodes aₓ and a_{y}; and
the step of matching further comprises the step of maximizing the following:
Q(Gᵣ,Gₛ)=ΣₓΣₘP(aₓ,αₘ)NodeSim(aₓ,αₘ)+ΣₓΣ_{y}ΣₘΣₙP(aₓ,αₘ)P(a_{y},αₙ)EdgeSim(r_{xy},γₘₙ),
where P(aₓ,αₘ) is a probability associated with two nodes, P(aₓ,αₘ) P(a_{y},αₙ) is a probability associated with two edges, NodeSim(aₓ,αₘ) is a similarity metric between nodes, and EdgeSim(r_{y},γₘₙ) is a similarity metric between edges.

8. The method of claim 1, wherein the step of generating a first structure further comprises the step of generating a first structure comprising information describing one or more of a reference type, an identifier of a potential referent, a semantic type of potential referents, a number of potential referents, one or more type dependent features, and a time stamp for the one or more referring expressions.

9. The method of claim 1, wherein the step of generating a first structure further comprises the step of generating a first structure comprising information describing, for each pair of referring expressions having a relationship, one or more of a connection between the pair of referring expressions, a direction of the connection between the pair of referring expressions, a semantic type relation between the pair of referring expressions, and a temporal relationship between the pair of referring expressions.

10. The method of claim 1, wherein the step of generating a second structure further comprises the step of generating the second structure comprising information describing one or more of an object identifier, a unique identifier, one or more attributes, a selection probability, and a time stamp for the one or more referents to which the one or more referring expressions might refer.

11. The method of claim 1, wherein the step of generating a second structure further comprises the step of generating a second structure comprising information describing one or more of a direction, a temporal relationship, and a semantic type for each relationship between pairs of the one or more referents.

12. The method of claim 1, wherein the step of generating a second structure further comprises the steps of:
determining multiple interaction events for one interaction between a user and a computer system, wherein each interaction event corresponds to a given one of the one or more referring expressions;
for each interaction event, generating a sub-structure comprising information describing one or more referents to which the given referring expression might refer and describing relationships, if any, between the one or more referents; and
combining the sub-structures into the second structure.

13. The method of claim 1, wherein the step of generating a second structure further comprises the steps of:
identifying one or more objects in user input, wherein each object is a potential referent to which one or more referring expressions in the user input might refer;
for each identified object, generating information, of the second structure, describing the object; and
generating information, of the second structure, describing relationships between the one or more objects.

14. The method of claim 1, wherein the step of generating a second structure further comprises the steps of:
generating a first sub-structure comprising information describing one or more first referents to which the one or more first referring expressions might refer and describing relationships, if any, between the one or more first referents;
generating a second sub-structure comprising information describing one or more second referents to which the one or more second referring expressions might refer and describing relationships, if any, between the one or more second referents; and
merging the first and second sub-structures to form the second structure by determining information indicating relationships between pairs of referents, each pair comprising a given first referent and a given second referent, the information comprising at least temporal order of the given first and second referents.

15. The method of claim 1, wherein the step of generating a second structure further comprises the steps of:
identifying one or more objects that are in focus, wherein each object is a referent to which one or more referring expressions in the focus might refer;
for each identified object, generating information, of the second structure, describing the identified object; and
generating information, of the second structure, describing relationships between the one or more objects.

16. The method of claim 1, wherein:
the step of generating a first structure further comprises the step of generating a graph comprising first nodes describing one or more referring expressions and comprising first edges describing relationships, if any, between the one or more referring expressions; and
the step of generating a second structure further comprises the step of generating a second structure comprising second nodes describing one or more referents to which the one or more referring expressions might refer and second edges describing relationships, if any, between the one or more referents.

17. The method of claim 16, wherein the step of matching further comprises the steps of:
measuring first similarities between pairs of nodes in the first and second structures, each pair comprising a first node and a second node;
measuring second similarities between edges corresponding to the pairs of nodes;
computing, for each of the nodes in the first and second structures, matching probabilities between a selected first node and a selected second node and between edges corresponding to the two selected nodes;
performing the step of computing until a value is maximized, the value determined by using the first and second similarities and the matching probabilities; and
determining a match exists between a given first node and a given second node when a matching probability corresponding to the given first and second nodes is greater than a threshold.

18. The method of claim 17, further comprising the step of outputting a match, the match comprising a referring expression, corresponding to the given first node, and a referent, corresponding to the given second node.

19. The method of claim 17, wherein:
the step of determining a match exists between a given first node and a given second node determines that matches exist between a given first node and multiple given second nodes; and
the method further comprises the step of requesting more information from a user to disambiguate a referring expression, corresponding to the given first node, and multiple referents, corresponding to the multiple given second nodes.

20. A system for reference resolution, the system comprising:
a memory that stores computer-readable code, a first structure, and a second structure; and
a processor operatively coupled to said memory, said processor configured to implement said computer-readable code, said computer-readable code configured to perform the steps of:
generating the first structure comprising information describing one or more referring expressions and describing relationships, if any, between the one or more referring expressions;
generating the second structure comprising information describing one or more referents to which the one or more referring expressions might refer and describing relationships, if any, between the one or more referents; and
matching, by using the first and second structures, a given one of the one or more referring expressions to at least a given one of the one or more referents, the step of matching satisfying one or more matching constraints, wherein the step of matching resolves one or more references by the given referring expression to the at least a given referent.

21. An article of manufacture for reference resolution, the article of manufacture comprising:
a computer-readable medium containing one or more programs which when executed implement the steps of:
generating a first structure comprising information describing one or more referring expressions and describing relationships, if any, between the one or more referring expressions;
generating a second structure comprising information describing one or more referents to which the one or more referring expressions might refer and describing relationships, if any, between the one or more referents; and
matching, by using the first and second structures, a given one of the one or more referring expressions to at least a given one of the one or more referents, the step of matching satisfying one or more matching constraints, wherein the step of matching resolves one or more references by the given referring expression to the at least a given referent.
